(19) United States
(12) Patent Application Publication
(10) Pub. No.: US 2008/0049129 A1
(43) Pub. Date: Feb. 28, 2008

(54) Imaging device with improved signal to noise performance

(76) Inventor: James H. Meacham, Arnold, MD (US)

Correspondence Address: ANDREWS KURTH LLP;Intellectual Property Department, Suite 1100, 1350 I Street, N.W., Washington, DC, 20005, US

(21) Appl. No.: 11/510,696

(22) Filed: Aug. 28, 2006

(51) Int. Cl. H04N 5/335

(52) U.S. Cl. 348/297

(57) ABSTRACT

A variable integration circuit processes an image based on variable pixel integration times. The variable integration circuit includes a threshold detect circuit that detects whether a threshold charge level has been reached at a pixel output. If the threshold charge has been reached at the pixel output, the threshold detect circuit generates a trigger indicating that the threshold charge has been reached. The trigger resets the pixel output. The variable integration circuit also includes a threshold detect time store circuit that receives the trigger and stores a time-to-threshold. The trigger resets the pixel output to an initial state.

### TECHNICAL FIELD

The invention relates to imaging devices, specifically to a circuit that provides improved signal to noise performance from solid state area array imaging devices.

### BACKGROUND

Use of solid state area array imaging devices (SSAAIDs) (e.g., charge coupled devices (CCDs), complementary metal oxide semiconductor (CMOS) devices, infrared imagers) is proliferating in both defense and commercial arenas. SSAAIDs are used to capture images received in the form of light, and find application in devices such as digital cameras, scanners, cell phones, surveillance devices in homeland security, as well as home protection.

SSAAIDs have X by Y number of pixels which form the planar focal plane imaging area. Each pixel of the SSAAID generates and holds an amount of charge proportionate to the intensity of incident light (i.e., photons), and the length of time the light is allowed to fall on the pixel. The stored charge representing the optical information is available in analog form across the pixels of the imaging array. The analog information is then shifted out of the array and is converted into a standard composite video signal digital form, which is then sent to a monitor and transmitter and/or recording device. The converted charge can be stored in digital memory for further processing before conversion to a composite video signal format.

Current SSAAIDs are limited in their ability to provide acceptable images in moderate to low light level conditions. Conventional devices interrogate each pixel at a fixed integration time to assess the level of charge that has accumulated. For example, the interrogation process involves a charge coupled transfer from one pixel to its neighbor until a pixel's charge information has been transferred to a common read outline on the Y axis. This information is then readout from the X axis on a line by line basis. This readout process to interrogate the entire X by Y array of pixels takes place at a fixed field rate (typically at a 60 Hz rate to match television standards). Thus, an array of pixels are read out approximately every 16.67 milliseconds. Within the fixed readout rates, conventional SSAAIDs convert the photon flux impinging on the two dimensional array into a composite video output signal that can be transferred to a standard video display. In low light level conditions, with fewer incoming photons to the imager, the signal-to-noise ratio (S/N) of the video output is very low, resulting in a grainy/noisy image in dark areas of the image.

Moreover, in low S/N situations, pixel to pixel sensitivity and illumination versus output signal curves, caused by material and manufacturing defects or variations, can create non-uniformities in the images, where the signal levels are not sufficient to overcome the sensitivity anomalies. Even slight material and/or manufacturing defects can further distort the resulting image or video.

In addition to the problems in low light level conditions, conventional imagers suffer from saturation in high light level conditions. If a large amount of light hits the imaging area, or a portion of the imaging area, the high brightness spots could overload the array pixel matrix or the video output amplifiers, and result in a distorted image. Although some SSAAIDs utilize additional anti-bloom channels to minimize the detrimental effects of high brightness spots, saturation still poses a problem.

As the incoming light (photons) is converted to stored charge in each pixel site, the analog information is shifted along from pixel to pixel in the image plane readout process. Each pixel to pixel transition can have intrinsic inefficiencies, so that with large arrays there is degradation in S/N by virtue of the large number of analog shifts required.

### SUMMARY

A variable integration circuit processes an image based on variable pixel integration times. The variable integration circuit includes a threshold detect circuit that detects whether a threshold charge level has been reached at a pixel output. If the threshold charge has been reached at the pixel output, the threshold detect circuit generates a trigger indicating that the threshold charge has been reached. The trigger resets the pixel output. The variable integration circuit also includes a threshold detect time store circuit that receives the trigger and stores a time to threshold. The trigger resets the pixel output to an initial state.

### BRIEF DESCRIPTION OF THE DRAWINGS

FIG. 1 illustrates an embodiment of a variable pixel integration circuit.

FIG. 2 illustrates an embodiment of an image device processor.

### DETAILED DESCRIPTION

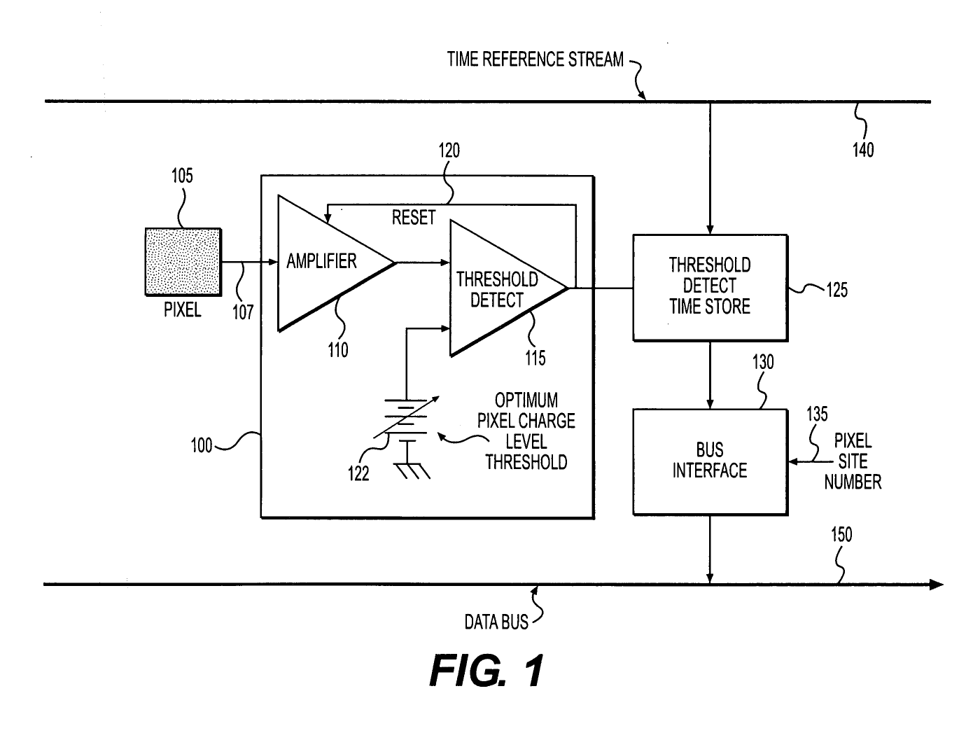

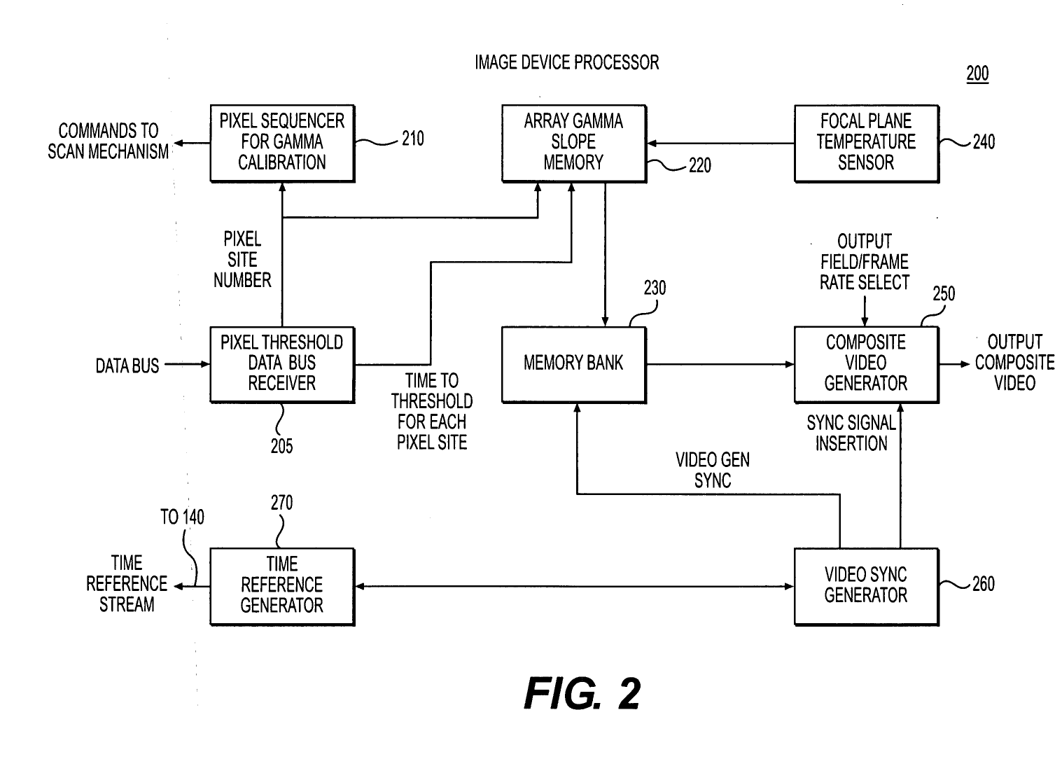

FIG. 1 illustrates an embodiment of a variable pixel integration (VPI) circuit 100. The VPI circuit 100 shown is given by example only. Additional circuits or components, such as ones shown in FIGS. 1 and 2, may be included in VPI circuit 100, in accordance with an embodiment. In an embodiment, VPI circuit 100 may include fewer components than as shown in FIG. 1.

VPI circuit 100 is coupled to a pixel 105, which may represent a single pixel or a portion or entire solid state area array imaging device (SSAAID) (not shown) including a plurality of pixels. A SSAAID has X by Y number of pixels, which form the planar focal plane imaging area. A SSAAID may include a charge coupled device (CCD), a complementary metal oxide semiconductor (CMOS) device, an infrared imager, or other type of imager or imaging device. Each of the imaging pixels accumulates charge as part of the process where incoming light photons come into contact with the pixel area and are converted to electrons. Pixel 105 is coupled to a threshold detect circuit 115, such as a comparator, either directly (not shown) or through an amplifier 110. The pixel 105 senses light, and generates an output charge 107 proportionate to the sensed light. As shown, the output charge 107 may first be amplified using amplifier 110 before it is provided to the threshold detect circuit 115. Optionally, the output charge 107 may be provided directly to the threshold detect circuit 115.

The threshold detect circuit 115 receives the output charge 107, either before or after it is amplified by amplifier 110, and compares the output charge 107 to a pixel charge threshold level 122 (a threshold charge). The threshold charge 122 may be a predetermined charge level, determined to have, for example, an optimum signal-to-noise ratio (S/N) for the corresponding pixel 105. For example, the threshold charge 122 may be a maximum charge level output by the pixel 105, prior to reaching its saturation point.

In an embodiment, the threshold charge 122 may be adjusted automatically to compensate for pixel characteristics over temperature (e.g., as measured or calculated), or for unique scene situations. For example, a unique scene situation may be a very bland image with low differential contrast. In this case, it may be desirable to increase the “gamma” of the image to expand the dynamic range of the analog video output from the imaging system. The “gamma” associated with a pixel or image may represent the pixel signal output vs. illumination at a fixed integration time. When the threshold in any pixel site (e.g., pixel 105) is reached, that pixel site resets and the time of that reset is sent from an imaging chip to a processor. In the processor, the reset time differential from the last reset for any particular pixel and the current reset time establishes what the integration time is for that pixel. Based on pre-established characterization of the device and the light level to integration time transfer curve, if may be possible to modify the curve for any specific pixel in the processor or by modifying the characteristics of the entire array by changing the threshold level that causes the pixels to reset.

The threshold charge 122 may be calibrated to be at an optimum level (e.g., an optimal S/N level) for a single pixel, or for a plurality of pixels. The threshold detect circuit 115 receives the output charge 107 and determines whether the output charge 107 is greater than or equal to the threshold charge 122. If the output charge 107 from pixel 105, or output by amplifier 110, is greater than or equal to the threshold charge 122, the output detect circuit 115 generates a threshold trigger 120.

In an embodiment, the trigger 120 is output to a device such as the threshold detect and time store device 125. The threshold detect and time store device 125 receives the trigger 120 and captures a time associated with the occurrence of the trigger 120 for the corresponding pixel. The time captured by the threshold detect and time store device 125 may be-the-actual time elapsed before the trigger was generated (i.e., a time-to-threshold) for the corresponding pixel. The time-to-threshold may represent an actual time duration for a pixel to reach its predetermined threshold charge 122, based on the comparison by the threshold detect circuit. In other words, the time-to-threshold is the measured or calculated total time it takes for the output charge 107 to reach the value of the threshold charge 122. The time-to threshold may be a measured time for the pixel to reach the threshold state from an initial state or from a reset state.

At an initial state, for example, the pixel 105 may be at a “zero” charge value (e.g., a minimal output charge), at the pixel's off state value (e.g., the charge value when no photons are sensed by the pixel), at some predetermined pre-charge condition (known as a “fat-zero” state), and/or at some level determined to optimize the performance of that particular imager/pixel material and/or configuration. The time-to-threshold may be determined based on the time it takes a pixel to reach the threshold charge 122 from an initial state.

Once the threshold detect circuit 115 determines that the output charge 107 meets or exceeds the threshold charge 122, the trigger 120, generated by the threshold detect device 115, may be used to reset the pixel output charge 107 value at pixel 105. The trigger 120 may be used to reset the pixel 105 to an initial state. In an embodiment, the pixel may be reset to a “fat zero” level, used as the reset level to allow some pre-charging of the pixel before exposure. The output charge 107 may be reset at the amplifier 110 or directly at the pixel 105 (not shown).

After the output charge 107 is reset, the pixel 105 again senses the incoming light and generates another output charge 107 proportionate to the sensed light. As described above, the output charge 107 may be provided to the threshold detect circuit 115 directly or through amplifier 110. Again, the threshold detect circuit 115 receives the output charge 107 and compares the output charge 107 to a threshold charge 122. If output charge 107 is greater than or equal to the threshold charge 122, the output detect circuit 115 generates a trigger 120. The threshold detect and time store device 125 receives the trigger 120 and captures the time-to-threshold (e.g., the measured time for the pixel to reach the threshold state from the initial state or reset state). The time-to-threshold may be stored at the threshold detect and time store device 125, and the trigger is once again used to reset the output charge 107. This process continues and the time-to-threshold for each pixel is measured, as described.

The time-to-threshold for each pixel 105 of, for example, the plurality of pixels in the pixel array of the SSAAID may be stored at the threshold detect and time store device 125, and/or other memory. Thus, the threshold detect and time store device 125, or other memory, may accumulate the time-to-threshold it takes for the associated pixel to reach its optimal S/N threshold trigger level (e.g., threshold charge 122).

In an embodiment, the threshold detect and time store device 125 may contain processing capabilities in addition to a memory. The processing capability may be used to calculate a time-to-threshold based on the triggers 120 received from the threshold detect circuit 115. The time-to-threshold may be determined or calculated based on the time reference stream 140 provided to the threshold detect and time store device 125.

As described above, each pixel accumulates a charge to a preset high S/N threshold level (e.g., threshold charge 122), and the time to reach the preset high S/N threshold level (e.g., time-to-threshold) is recorded. In addition to being used as mechanism to reset the pixel 105, the trigger 120 may also be used as an indication based on which the time-to-threshold and/or other data, for the associated pixel 105, is transmitted to an image device processor (described below). The time-to-threshold information is output to a data bus 150 that transmits time-to-threshold information and/or other information to the image device processor. A bus interface 130 may be used to input data in the data bus 150. The bus interface 130 may also be used to insert a pixel site number 135 identifying the location of the pixel for which the time-to-threshold is being transmitted to the data bus 150.

In one example, the data bus 150 may be an Ethernet or other timeslot type bus, and the bus interface may insert the time-to-threshold information and the pixel location information into the first open timeslot in the data bus.

Optionally, the bus interface 130 may be incorporated into the threshold detect and time store device 125. In an embodiment, the pixel site number 135 may be inserted at the threshold detect and time store device 125, and paired with the associated time-to-threshold information. The paired time-to-threshold information and pixel site number are provided to the data bus 150.

As described above, each pixel's field rate is determined by the time it takes (e.g., time-to-threshold) for that pixel to reach its optimum threshold level (e.g., threshold charge 122). Thus, the image relayed to the image device processor may be generated based on information from each pixel that is compared to an optimum threshold value. The refresh rate for sensing the charge at the pixels is variable for the entire array. In an embodiment, the field rate for the entire array may be dependent on the least illuminated pixel to accumulate enough charge to reach its threshold trigger level. The longer refresh rates for individual pixels only occurs for pixels that have low levels of illumination. Pixels with high illumination levels, and subsequent rapid accumulation of charge, will reach their corresponding threshold charge quickly, and thus may reach their refresh rates faster than the normal fixed field refresh rates, as conventional imaging arrays. Pixels receiving higher illumination levels accumulate charge faster and are updated at a faster rate than those pixels receiving lower illumination, which take longer to accumulate charge.

FIG. 2 illustrates an embodiment of an image device processor 200. The image device processor 200 processes the time-to-threshold information, the pixel location information and/or any other information to generate an output, which may be an image or video. The image device processor 200 may include a data receiver 205 that receives information from the data bus 150. The data receiver de-multiplexes the information on the data bus 150, and directs the de-multiplexed information to appropriate modules or components of the image device processor 200. The data receiver 205 sends pixel location information to the pixel sequencer 210. In SSAAIDs where pixel to pixel sensitivity or light transfer characteristics my differ due to production tolerance limitations, the pixel sequencer 210 uses the pixel location information to calibrate pixels using, for example, gamma calibration. The pixel sequencer 210 outputs commands to the SSAAID or CCD scan mechanism to perform gamma calibration. As indicated above, the gamma associated with a pixel may represent the pixel signal output vs. illumination at a fixed integration time.

The pixel site information as well as the time-to-threshold information is provided to a gamma slope generator 220. The gamma slope generator 220 maintains the threshold charge levels for each pixel, and receives the time-to-threshold information associated with each pixel from the data receiver 205. The gamma slope generator 220 creates and maintains a gamma slope for each pixel, which represents a graph showing pixel signal output charge (e.g., in millivolts) vs. illumination (e.g., foot-candles) for each pixel. The graphs may be used to calibrate the VPI circuit 100 and generate output images by image device processor 200. The graphs associated with each pixel may be stored in local memory of the gamma slope generator 220 or other memory.

Each pixel of a SSAAID may be subject to manufacturing defects or variations that effect the output of the pixel or SSAAID array. These imperfections can be significant for high quality imaging systems. In an embodiment, the SSMID may include a focal plane temperature sensor that can be used to compensate for variations in the array. The temperature associated with the array may be received and stored at the temperature sensor memory 240 and provided to the gamma slope generator 220. The temperature may be used to, for example, compensate for gamma variations, and to optimize the charge threshold for a pixel or array. Gamma variations may also be temperature sensitive so that a pre-calibration of the array, pixel by pixel at different temperatures and illumination levels, may provide an absolute base from which to determine a video level output per pixel that is highly correlated with the photon flux received at that pixel.

Outputs from the gamma slope generator 220 may be output to memory 230. The memory 230 may store time-to-threshold information, the pixel location information and/or any other information. The time-to-threshold for each pixel can be transferred through the storage gamma curves per pixel to the video level that corresponds to the photon flux at that site. These levels may be stored on a continuous basis in the memory 230. The memory 230, which acts as a scan converter, may be read out by a composite video generator 250, at a standard field rate (e.g., a 60 Hz rate to match television standards) to form the video stream of a standard composite video signal. The readout reflects the latest inputs to the memory 230 at that time.- Some pixels- with high input illuminations may have been updated numerous times during a standard field rate period. Other pixels may still be accumulating charge and their corresponding threshold level will be reflected in a subsequent field.

The composite video generator 250 receives the time-to-threshold information, the pixel location information and/or any other information based on a standard field rate, and generates an output composite video. The composite video generator 250 may receive external control information such as the field rate to determine the rate at which the information will be read out from memory 230.

A video sync generator 260 provide a video synchronization signal to the composite video generator 250. The video sync generator 260 may also provide a video synchronization signal to memory 230. Typically, the output composite video signal conforms to the Electronic Industry Alliance (EIA) Standard RS170 for standard broadcast quality standards, or variants that reflect high definition composite video formats.

A time reference generator 270 generates a time reference stream used by the VPI 100 to determine the time-to-threshold, for example.

In an embodiment, the image device processor 200 generates a gamma slope (i.e., charge vs. illumination curve) for each pixel in the array. The image processor 200 may establish the appropriate threshold charge for each pixel, and may be used to calibrate the threshold charge for its optimum value. As the imaging array generates threshold trigger indications, the pixel site and the time-to-threshold for that pixel to achieve enough S/N to trigger is sent to its corresponding storage site in the processing array. While the image processor 200 may monitor each pixel site at varying refresh rates (e.g., based on the time-to-threshold), the image processor is interrogated at the standard television field rates (e.g., 60 Hz for US and 50 Hz for other countries). Since the output of each pixel is based on the corresponding threshold charge, the technique described herein may provide a higher S/N image output. The described method and apparatus may find application in myriad of devices such as commercial digital cameras, surveillance equipment, night vision devices, telescopes (e.g., used in astronomy), and any number of other imaging devices.

In one embodiment, the information provided by a pixel, such as pixel 105, or VPI circuit 100, may be the time-to-threshold values associated with the pixel 105. The time-to-threshold values are transmitted to a digital processor 200 that processes the time-to-threshold values to generate analog level, or representative digital level, image signals. The analog level or digital level image signals are used to correlate the time-to-threshold values with the charge level vs. time transfer curve characteristics based on a imaging device's pixel characteristics (e.g., the gamma characteristic of a particular material and/or pixel construct). The time-to-threshold values associated with each pixel is used, via stored pixel transfer or gamma curves, to establish the per pixel illumination levels. The generated pixel illumination levels are processed by the image processor 200 to output still images or video based on time-to-threshold values associated with individual pixels of an array.

The process as described herein is a highly digital process that may be resistant to external noise or conditions. Analog signals of any kind are vulnerable to noise which may be induced through varying power supply lines or through ground or common loops that bring extraneous current into the imager video line. External sources like electromagnetic interference can also corrupt analog signals, particularly wide bandwidth video lines. By converting the light exposure level in a single pixel immediately to a digital time to threshold signal, many problems that plague analog lines may be avoided. A digital signal is all about high signal to noise “ones” and “zeros” and thus all but immune from external interference signals that would distort analog signals, since every increment of an analog signal swing may be susceptible to interference that is highly visible (e.g., as a distorted or blurry image) when that signal is converted to video and placed on a video display monitor.

In an embodiment, the imaging device is self optimizing over all light level conditions, thus iris or neutral density filter control may not be required to keep the imaging sensor from saturating. Because each pixel resets once it has reached its optimum S/N threshold level, the imaging device never reaches a saturation point anywhere on the two dimensional array. This feature also eliminates streaking that is characteristic of conventional SSAAIDs due to isolated illumination overloads on the device.

In an embodiment, the self optimizing circuit and/or image array eliminates the need to interrogate the pixel array by analog charge shifting from pixel to pixel, as in existing arrays. In an embodiment of the invention, each pixel may establish an optimum integration time (e.g., the time-to-threshold), and the time-to-threshold information is multiplexed in a data stream for processing the image, without the need to scan the pixel array or the need for any inter-pixel analog format charge transfers. There is no pixel to pixel analog charge transfers required to get the image information from the image plane or array. The method and apparatus described herein offers a nearly all digital imaging device with minimal analog functions, compared to existing state of the art SSAAIDs. In an embodiment, the analog functions may occur only on the image plane of the array where the photon to charge conversion and the threshold trigger detect may occur. The described method and apparatus may provide improved performance, and reduce image array and image system complexity. The described imager self optimization may eliminate the need for light control mechanisms such as iris control or neutral density filter insertion, for example. An embodiment of the invention may provide a significant reduction in imaging circuit complexity and cost savings for portable imaging systems, such as digital cameras, telephone based imagers and video cameras used for broadcasting.

In an embodiment, a variable integration circuit processes an image based on variable pixel integration times, such as a variable time to threshold. The variable integration circuit includes a threshold detect circuit that detects whether a threshold charge level has been reached at a pixel output. If the threshold charge has been reached at the pixel output, the threshold detect circuit generates a trigger indicating that the threshold charge has been reached. The trigger resets the pixel output to an initial state. The variable integration circuit also includes a threshold detect time store circuit that captures, from a master clock line, the time at which the pixel site was reset due its having reached its threshold trigger/reset state (i.e., the time-to-threshold).

Where conventional arrays build a charge within a fixed integration frame time, an embodiment of the invention establishes a variable integration time based on the time-to-threshold conversion.

An embodiment of the invention may provide improved signal to noise performance from solid state area array imaging devices and that may provide a direct digital output from each pixel of the array as well self optimizing the image over varying light levels.

The terms and descriptions used herein are set forth by way of illustration only and are not meant as limitations. Those skilled in the art will recognize that many variations are possible within the spirit and scope of the invention as defined in the following claims, and their equivalents, in which all terms are to be understood in their broadest possible sense unless otherwise indicated.

What is claimed is:

1. An imaging device for generating an image based on variable pixel integration times, comprising:
a plurality of pixels, wherein each pixel of the plurality of pixels senses light and generates an amount of charge proportionate to sensed light; and
means for comparing coupled to each pixel of the plurality of pixels, wherein the means for comparing compares the generated amount of charge, proportionate to the sensed light associated with each pixel, to a threshold charge level, and if the means for comparing determines that the generated amount of charge is equal to or greater than the threshold charge level, then the means for comparing generates a trigger indicating that the threshold charge level has been reached at the associated pixel.

2. The imaging device of claim 1, further comprising:
an amplifier, wherein the amplifier is coupled between each pixel and the means for comparing.

3. The imaging device of claim 1, wherein the trigger generated by the means for comparing resets the associated pixel to an initial state.

4. The imaging device of claim 1, further comprising:
means for detecting, wherein the means for detecting receives the trigger for the associated pixel and determines a time-to-threshold for the associated pixel.

5. The imaging device of claim 4, further comprising:
a time reference stream provided to the means for detecting.

6. The imaging device of claim 4, wherein the means for detecting determines a location of the associated pixel, and outputs the location of the associated pixel and the time-to-threshold for the associated pixel.

7. The imaging device of claim 6, further comprising:
an image processor, wherein the image processor processes data including the location of the associated pixel and the time-to-threshold for the associated pixel to generate the image.

8. The imaging device of claim 7, wherein the image processor further comprises:
a scan converter, wherein the scan converter receives the location of the associated pixel and the time-to-threshold for at least a portion of the plurality of pixels, and generates an output stream representing the image at a standard scan rate.

9. The imaging device of claim 7, wherein the image processor further comprises:
a time reference generator, wherein the time reference generator generating the time reference stream.

10. An imaging device comprising:
a plurality of pixels, wherein each pixel of the plurality of pixels senses light and generates an amount of charge proportionate to sensed light;
a threshold detect circuit, wherein the threshold detect circuit detects whether a threshold charge level has been reached at each pixel of the plurality of pixels, and if the threshold charge has been reached at the corresponding pixel being detected, the threshold detect circuit generates a trigger indicating that the threshold charge has been reached.

11. The imaging device of claim 1, wherein the threshold detect circuit is coupled to each of the plurality of pixels.

12. The imaging device of claim 1, further comprising:
an amplifier, wherein the amplifier is coupled between each pixel and the threshold detect circuit.

13. The imaging device of claim 1, further comprising:
a threshold detect time store circuit receives the trigger and stores a time when the trigger was detected.

14. The imaging device of claim 1, wherein the trigger resets the pixel to regenerate charge based on sensed light.

15. A method or generating an image based on variable pixel integration times, the method comprising:
determining whether a first charge generated by a pixel based on sensed light is greater than or equal to a predetermined threshold;
if the first charge generated by the pixel is greater than or equal to the predetermined threshold, generating a first trigger; and
calculating a first time for the generation of the first trigger.

16. The method of claim 15, further comprising:
resetting the pixel to an initial state using the first trigger.

17. The method of claim 15, further comprising:
determining a location of the pixel; and
transmitting the first time and the determined location of the pixel to an image processor.

18. The method of claim 17, further comprising:
processing the first time and the determined location of the pixel to generate the image.

19. The method of 16, further comprising:
determining whether a second charge generated by the pixel, after reset, based on sensed light is greater than or equal to the predetermined threshold;
if the second charge generated by the pixel is greater than or equal to the predetermined threshold, generating a second trigger; and
calculating a second time for the generation of the second trigger.

20. The method of claim 19, further comprising:
resetting the pixel to an initial state using the second trigger.

21. The method of claim 19, further comprising:
determining a location of the pixel; and
transmitting the second time and the determined location of the pixel to an image processor.

22. A variable pixel integration circuit comprising:
a threshold detect circuit, wherein the threshold detect circuit detects whether a threshold charge level has been reached at a pixel output, and if the threshold charge has been reached at the pixel output, the threshold detect circuit generates a trigger indicating that the threshold charge has been reached and the trigger resets the pixel output.

23. The variable pixel integration circuit of claim 22, wherein the threshold detect circuit is coupled to each of a plurality of pixels.

24. The variable pixel integration circuit of claim 22, further comprising:
an amplifier, wherein the amplifier is coupled between a pixel and the threshold detect circuit.

25. The variable pixel integration circuit of claim 22, further comprising:
a threshold detect time store circuit that receives the trigger and stores a time-to-threshold.

26. The variable pixel integration circuit of claim 22, wherein the trigger resets the pixel output to an initial state.

27. A processor implemented method for generating an image, comprising:
collecting time-to-threshold values associated with each pixel of a plurality of pixels in an array;
processing the collected time-to-threshold values to generate pixel illumination levels associated with each pixel;
generating an output image based on the generated pixel illumination levels associated with each pixel.

28. A variable pixel integration circuit comprising:
a threshold detect circuit;
a trigger indicating that a threshold charge level at a pixel output has been reached, wherein the trigger resets the pixel output charge if the threshold charge level at the pixel output has been reached.

29. The variable pixel integration circuit of claim 28, further comprising:
a threshold detect time store circuit that receives the trigger and stores a time-to-threshold.

30. The variable pixel integration circuit of claim 28, wherein the trigger resets the pixel output to an initial state.
